(19) United States
(12) Patent Application Publication
(10) Pub. No.: US 2011/0253171 A1
(43) Pub. Date: Oct. 20, 2011

(54) Chemical Composition and Methods for Removing Epoxy-Based Photoimageable Coatings Utilized In Microelectronic Fabrication

(76) Inventor: John Moore, Camarillo, CA (US)

(21) Appl. No.: 13/087,571

(22) Filed: Apr. 15, 2011

Related U.S. Application Data
(60) Provisional application No. 61/324,673, filed on Apr. 15, 2010.

(51) Int. Cl. B08B 3/00; C11D 7/60

(52) U.S. Cl. 134/6; 510/175

(57) ABSTRACT

The present invention is a chemical composition to remove epoxy-based photoimageable coatings that include a solvent system to dissolve and rinse away the coating, an acidic additive that hydrolyzes the coating and releases a plurality of monomeric forms to the solvent, a plurality of inhibitors that protect any exposed substrate and a surfactant to lower a surface tension of the coating on the substrate. The composition can be utilized with a method for removing a partial cured and a fully cured epoxy-based photoimageable coating from a substrate with the composition to remove epoxy-based photoimageable coatings.

This application claims priority to U.S. Provisional Application 61/324,673 filed on Apr. 15, 2010, the entire disclosure of which is incorporated by reference.

### TECHNICAL FIELD & BACKGROUND

This invention relates to a chemical stripper composition for removing epoxy-based compounds utilized as photoimageable coatings utilized in microelectronic fabrication. For partial-cure epoxy coating removal, the composition will remove epoxy-based compounds within minutes at room temperature using conventional immersion or spray systems and operate within seconds at elevated temperatures. Full-cure epoxy coatings, recognized as resistant to conventional organic strippers, are removed with other stripping compositions applied in the method described in U.S. patent application Ser. No. 12/413,085 (2009), Moore et al.

During removal of partial or full-cure epoxy coatings, results are observed to be in terms of a full dissolution of the coating, not the conventional lifting, break-up, or generation of pieces of the coating which can result in redeposited contamination of the coating. Full dissolution offers the advantage of efficient rinsing and filtration of the recycled composition. When utilized in combination with metals at given processing times, the composition is found to be safe with relatively soft metals, such as aluminum and copper. The composition is non-toxic, easily rinsed with water, and when processing epoxy coatings at relatively low temperature, the composition may be sent directly to a common flammable organic waste stream collection system that may be typical to most semiconductor fabrication areas. The composition has been found to be especially useful in semiconductor wafer processing.

Epoxy-based polymers, in the presence of certain cross-linking photo initiators, will cure to a smooth and highly chemically resistant framework. This cured polymeric material is utilized to produce patterns or masks, which become the basis for depositing microcircuits in semiconductor manufacturing. Epoxy-based insulating coatings are commonly utilized in back-end semiconductor manufacturing to isolate wire and solder ball contacts. These coatings are designed to be permanent and become part of the final produced device. For a variety of reasons, there may be a need to remove epoxy-based coatings, whether it is due to a process excursion (i.e. re-work) or when the coating has been utilized as a mask (i.e. photoresist, resist).

During the manufacture of semiconductor microcircuits, various inorganic substrates such as single and polycrystalline silicon, hybrid semiconductors such as gallium arsenide, and metals, are coated with a polymeric organic substance which forms a resistant framework of a permanent or temporary design and exhibits a pattern after undergoing a photolithographic process. The polymeric framework may be utilized to insulate conductors or protect selected areas of the substrate surface, such as silicon, silicon dioxide, or aluminum, from the action of chemicals in both wet (solution) and dry (plasma) forms. In the case of the material being utilized as a resist, exposed areas of the substrate may carry out a desired etch (removal) or deposition (addition) process. Following completion of this operation and after subsequent rinsing or conditioning, it is necessary that the resist and any application post-etch residue be removed to permit essential finishing operations. Upon removal of the resist, specific micro-etched or deposited patterns are left behind. The masking and patterning processes are repeated several times to produce layered microcircuits that comprise part of the final semiconductor device. Each step requires complete resist stripping and cleaning; to ensure that the final form device is produced at relatively high yields and performs satisfactorily.

To fully appreciate the challenges in removing such materials, it is important to understand the chemistry of the organic coatings and how they are utilized in semiconductor manufacturing processes. Organic insulators comprise many chemical families, that include polyimide (PI), polybenzoxazole (PBO), bis-benzocyclobutene (BCB), and epoxy, while resists include positive polyhydroxystyrene or novolak resins as well as negative acrylic, cyclized isoprene (rubber), and epoxy-based resins. Epoxy-based resins are preferred over other conventional materials due to their rapid processing conditions, rigid character, and robust chemical resistance. The epoxy-based polymer cures to a three dimensional product by a process involving cationic photo-initiated ring opening of the epoxy, followed by condensation polymerization, leading to between-chain crosslinking. The result is a rigid polymer network utilized as a permanent insulator or as a temporary resist.

Typical of most epoxy-based curing systems, there is an ultraviolet (UV) light exposure step followed by a post-exposure bake stage that is typically a thermal heating up to approximately 100° C. The combination of these steps facilitates the photochemical reaction and subsequent polymerization to achieve a partial-cure state. A full-cure state is achieved when a hard-bake step is heated above 100° C. to ensure complete cross-linking. During the photoimaging process, unexposed material is dissolved and rinsed away (developed) from the exposed material, leaving behind a negative image as compared to the pattern in which light has traveled.

When viewing the remaining pattern under a high-resolution microscope (i.e. scanning electron microscopy or SEM), the resultant sidewall of the resist is commonly not vertical (i.e. 90°) from top to bottom. In fact, the pattern wall has a negative slope (i.e. less than 90°), as measured from the bottom plane of the developed area. This sloped condition results when a reduced efficiency of the photochemical reaction or crosslinking is exhibited as light proceeds downward through the epoxy-network, causing less of the polymer to be imaged and cured. At the pattern edge, the polymer near the top surface is fully exposed, crosslinks and increases density of its structure, allowing less light to pass, resulting in a reduced exposure to the material near the bottom. To this end, a greater cross-sectional area of the coating at the top of the profile is cured, whereas less curing occurs near the bottom. During the development process, a greater cross-sectional amount of material near the bottom is soluble and is removed. The resulting cross-sectional pattern (mask) is viewed to be relatively larger at the top than at the bottom, giving the effect of a negative slope.

This negative slope is useful when the epoxy-based system is utilized as a mask for depositing thick metal lines in a process commonly referred to as deposition and lift-off. Following the patterning process, metal is coated onto the pattern either by plasma deposition or wet chemical plating. After deposition, the polymer mask is stripped from the surface, and along with it any unwanted metal that was originally deposited directly onto the pattern. This occurs by a solvent stripping process whereby solvent molecules penetrate the cured polymer mask from the side at the negative slope profile. As the solvent penetrates, the mask begins to swell and dissolve, causing the unwanted metal to lift-off. Once the metal and mask enters the bulk chemical, it is filtered away, allowing the chemistry to be reutilized or recycled. After the mask is stripped and metal is lifted off and rinsed away, the metal lines that were originally deposited within the mask pattern are left behind.

Reliability issues may arise in a lift-off process or for any stripping process, due to the variability in exposure conditions. If this variability is due to factors that affect the curing process, it will result in a change of the chemical make-up of the resist. The factors that control a curing process include light, temperature and oxygen. For purposes of this description, the focus will be limited to temperature, one of the most common variables in a manufacturing process. Temperature changes may be due to variability in substrate conductivity or thermostat controls when using a hotplate or an oven. An organic material exposed to different temperatures may exhibit varying densities in its bulk form and show changes in surface composition. This is observed in oven-cured polymers where a material coating is heated by convection.

It is generally observed that polymers exposed to convection heat will cure to a higher extent due to the formation of a surface skin. The surface skin results from direct contact with heat in the environment (i.e. convection heat), causing accelerated curing to form a higher bulk density polymer at the surface (i.e. skin). The polymer skin commonly solvates much slower than a material that is cured internally or at lower temperatures. Accordingly, temperature variation is a common process variable, which may produce coatings, which exhibit a range of solubility characteristics. A composition that is designed to solvate polymers exposed to temperature extremes therefore will be robust for general cleaning processes.

A frequently utilized method in removing cured epoxy-based coatings from a substrate is by direct contact with an organic stripper. The stripper penetrates the polymer surface and causes it to swell, while a reactive ingredient hydrolyzes and severs the cross-linked portions. As this process continues, more and more of the polymer is exposed until the products of hydrolyzation and dissolution are broken down and dissolved into relatively small chains that can be filtered and removed.

The currently utilized stripping compositions have usually been less than satisfactory or have the distinct disadvantage of presenting unacceptable toxicity and/or pollution problems from the disposal of compounds such as phenol, cresol, and chlorinated hydrocarbons. Other known compositions for removing polymeric organic substances include inorganic compounds that are not suitable for use around electronic devices such as, aqueous sulfuric acid compositions containing a significant amount of fluoride ion to reduce metallic dulling and corrosion, as exemplified in U.S. Pat. No. 3,932,130. Some photoresist strippers require the presence of fluoride ion stabilizers to prevent metallic corrosion and operate at elevated temperatures. Although these strippers may provide value to industrial applications, they are deemed to be too aggressive for the soft metals utilized in semiconductor devices.

Efficiency and selectivity are important desirable characteristics of a stripper composition. There is a need for an improved stripping composition, which will remove the polymeric organic composition from a coated inorganic substrate without corroding, dissolving or dulling the surface of the metallic circuitry or chemically altering the inorganic substrate, especially in the microelectronic fabrication industry.

### SUMMARY OF THE INVENTION

An embodiment of the present invention provides a composition to dissolve and remove epoxy-based coatings from semiconductor substrates that include alcohols, amides, esters, ethers, glycol ether esters, glycol ethers, glycols, ketones, lactates, or sulfoxides, one or more additives that include an alkyl-sulfonic acid, formic acid, fatty acids, sulfuric acid, nitric acid, or phosphoric acids and an inhibitor defined as a protecting agent to include chelating, complexing, or reducing agents of the known varieties, including benzylic hydroxides such as catechol, triazoles, imidazoles, borates, phosphates, and alkyl or elemental silicates, ethylene diaminetetraacetic acid, diethylenetriaminepentaacetic acid, nitrilotriacetic acid, and 2,4-pentanedione, reducing sugars, hydroquinones, glyoxal, salicylaldehyde, fatty acids such as citric and ascorbic acid, hydroxylamines, or vanillin, and surfactants representing one or more of the known varieties, including fluorinated systems, nonionic nonyl-phenols and nonyl-ethoxylates, anionic forms that include alkyl-sulfonates, phosphate esters, and succinates.

One embodiment of the present invention provides a method that aids in semiconductor manufacturing by dissolving and removing epoxy-based coatings in a partial-cure condition by using a simple immersion or spray process at room temperature or a slightly elevated temperature.

An embodiment of the present invention offers an advantage over conventional strippers, which do not dissolve partial-cure coatings and are ineffective on full-cure epoxies.

An embodiment of the present invention provides an organic stripping composition and system for dissolving epoxy-based coatings. The system operates effectively without the introduction of toxic substances, operates at moderate temperatures, and is deemed safe to adjacent metals. The utility of the system is particularly advantageous for semiconductor fabrication lines where rapid processing at low temperatures and using a simple rinse is effective for producing clean substrates.

An embodiment of the present invention describes a robust chemical stripper designed to dissolve and remove fully cured epoxy-based coatings.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase in one embodiment is utilized repeatedly. The phrase generally does not refer to the same embodiment, however, it may. The terms comprising, having and including are synonymous, unless the context dictates otherwise.

The composition and methods for removing epoxy-based photoimageable coatings utilized in microelectronic fabrication have particular applicability to semiconductor wafer fabrication in the removal of epoxy-based coatings and residues from semiconductor wafers. Such organic substances are present on wafers during back-end wafer-level packaging in a wafer bumping process. The composition and methods are particularly suitable for the removal of epoxy-based coatings identified as hard-to-remove, or in the case of a full-cure condition, resistant to conventional cleaners. The terms stripping, removing, and cleaning are utilized interchangeably and the terms stripper, remover, and cleaning composition are also utilized interchangeably. The indefinite articles “a” and “an” are intended to include both the singular and the plural noun forms. All composition ranges are inclusive and combinable in any order except where it is clear that such numerical ranges are constrained to add up to 100%. The term “wt %” means weight percent based on the total weight of the stripping composition, unless otherwise indicated.

The composition and method are particularly adapted for removing epoxy-based coatings. These coatings are employed in the fabrication of substrates for electronic devices on substrates such as wafers or flat panel displays, which may include various layers and structures such as metal, semiconductor and associated organic materials. Typical substrate materials include semiconductor materials such as silicon, gallium arsenide and indium phosphide and sapphire, as well as glass and ceramic and other suitable semiconductor materials.

The composition and method quickly and effectively dissolve and remove epoxy-based coatings from inorganic substrates, from metallic, non-metallic and metalized non-metallic substrates. The composition includes an acidic ingredient, which hydrolyzes epoxy polymeric substances and releases their monomeric forms to a bulk solvent, which then is rinsed from the substrate. The dissolving and removing of epoxy-based polymers represents a desirable processing condition for fabricating microcircuits in electronic manufacturing. Although the organic substances to be removed may be cured to a hard and chemically resistant framework when exposed to the customer's process, the composition and method are found to maintain a relatively acceptable performance.

The method for stripping an organic substance from an inorganic substrate brings the composition into direct contact with the substrate, with or without heat, for a given time sufficient to dissolve the epoxy-based coating and remove the resulting species by rinsing with water. This process condition occurs in immersion, spray, or systems that offer a combination of tasks. After a predetermined time of exposure, the substrates are removed from a bath or chamber and are rinsed with water, isopropanol (IPA) or some other demonstrated chemistry, and dried. Conditions of the exposure may be at a variety of heating conditions in the approximate range of room temperature 20° C., to greater than 100° C. Typical performance in using the composition provides complete dissolution within approximately 5 minutes at room temperature and reduced to below 1 minute at approximately 60° C. These results are in stark contrast with conventional stripper compositions, which do not dissolve the epoxy-based coating when exposed at relatively high temperatures (i.e. at approximately 100° C.) for more than approximately 1 hour.

When a full-cure epoxy-based coating must be dissolved and removed, the composition and method differ from a conventional stripping method described in U.S. patent application Ser. No. 12/413,085 (2009), Moore et al. The composition is applied as a coating to an inorganic substrate, followed by heating the substrate leading to penetration of the epoxy matrix and an initial reactive bond breaking. The heating rate is relatively rapid and continues until a desired temperature is reached and is maintained for a desired period of time until the matrix is emulsified. Rinsing the treated substrate with water then occurs and is followed by a drying step. The overall method involves three general but distinct steps that include coating the substrate, heating the substrate and rinsing the substrate. Typical performance in using the composition and method results in complete dissolution and removal of the coating within approximately 1 minute at a range of temperatures between approximately 100-250° C. These results are in relative stark contrast with conventional composition strippers, which have no detectable effect on the epoxy-based coating when exposed at an approximate temperature of 100° C. for more than approximately 1 hour.

The composition comprises a solvent system which include one or more esters of structures R—CO2R1, glycol ether esters of structures R2-CO2C2H4OC2H4-OR3, R4-CO2C3H6OC3H6-OR5 and R6OCO2R7, alcohols selected from structures R8OH, R9OC2H4OC2H4OH, R10OC3H6OC3H6OH, R11OC2H4OH, and R12OC3H6OH, ketones selected from structures R13COR14, sulfoxides selected from structure R15SOR16, and amides such as N,N-dimethyl formamide, N,N-dimethyl acetamide, and N-methylpyrolidone, wherein R, R1, R2, R3, R4, R5, R6, R7, R8, R9, R10, R11, R12, R13, R14, R15, and R16 are independently selected from C1-C14 alkyl groups, wherein R, R1, R13, R14 may be selected from C1 to C8 alkyl groups. To assist in the coating application, relatively high vapor pressure solvents may be chosen that include methyl acetate, ethyl acetate, isopropyl acetate, methyl propionate, and ethyl propionate, and ketones such as acetone, methyl ethyl ketone, and methyl propyl ketone.

Suitable primary solvents include, but are not limited to ketones such as cyclohexanone, 2-heptanone, methyl propyl ketone, and methy amyl ketone, esters such as isopropyl acetate, ethyl acetate, butyl acetate, ethyl propionate, methyl propionate, gammabutyrolactone (BLO), ethyl 2-hydroxypropionate (ethyl lactate (EL)), ethyl 2-hydroxy-2-methyl propionate, ethyl hydroxyacetate, ethyl 2-hydroxy-3-methyl butanoate, methyl 3-methoxypropionate, ethyl 3-methoxy propionate, ethyl 3-ethoxypropionate, methyl 3-ethoxy propionate, methyl pyruvate, and ethyl pyruvate, ethers and glycol ethers such as diisopropyl ether, ethyleneglycol monomethyl ether, ethyleneglycol monoethyl ether, and propylene glycol monomethyl ether (PGME), glycol ether esters such as ethyleneglycol monoethyl ether acetate, propyleneglycol methyl ether acetate (PGMEA), and propyleneglycol propyl ether acetate, aromatic solvents such as methylbenzene, dimethylbenzene, anisole, and nitrobenzene, amide solvents such as N,N-dimethylacetamide (DMAC), N,N-dimethylformamide, and N-methylformanilide, and pyrrolidones such as N-methylpyrrolidone (NMP), N-ethylpyrrolidone (NEP), dimethylpiperidone, 2-pyrrole, N-hydroxyethyl-2-pyrrolidone (HEP), N-cyclohexyl-2-pyrrolidone (CHP), and sulfur containing solvents such as dimethyl sulfoxide, dimethyl sulfone and tetramethylene sulfone.

Although these organic solvents may be utilized either individually or in combination, a solvent system can contain 3-methoxy-3-methyl-1-butanol (MMB, CAS# 56539-66-3, Kuraray Co., LTD). The solvent system includes one or more of these solvents at approximately 15 weight percent to approximately 95 weight percent, the typical amount being approximately 80 weight percent to approximately 95 weight percent, and a relatively frequent typical amount being approximately 85 weight percent to approximately 93 weight percent. The composition also includes approximately 100 parts-per-million (ppm) to approximately 85 weight percent of an alkyl-sulfonic acid such as methane sulfonic (MSA), para-toluenesulfonic (PTSA), and dodecylbenzene sulfonic acid (DDBSA), formic acid, fatty acids, sulfuric acid, nitric acid, or phosphoric acids. The composition includes an inhibitor defined as a protecting agent for the substrate which may include chelating, complexing, or reducing agents, including benzylic hydroxides such as catechol, triazoles, imidazoles, borates, phosphates, and alkyl or elemental silicates, ethylenediaminetetraacetic acid, diethylenetriaminepentaacetic acid, nitrilotriacetic acid, and 2,4-pentanedione, reducing sugars, hydroquinones, glyoxal, salicylaldehyde, fatty acids such as citric and ascorbic acid, hydroxylamines, or vanillin and a surfactant including nonionic nonyl-phenols and nonyl-ethoxylates, anionic forms that include alkyl-sulfonates, phosphate esters, and succinates, and fluorinated systems.

The composition functions by maintaining a solvency environment when utilized on epoxy-based substances utilized for coatings or other applications. When a partial-cure condition exists and when exposure conditions include ambient or moderate temperatures up to approximately 60° C. and a composition which contains the solvent system and additive is applied, the coating is dissolved and removed rapidly. When a full-cure epoxy condition exists, the composition is applied as a coating, heated, and rinsed with water to remove the coating to completion. Further details on the method utilized for a full-cure epoxy coating removal are described in U.S. patent application Ser. No. 12/413,085 (2009), Moore et al. The acidic additive of the composition provides advantages to achieve suitable dissolution rates due to hydrolyzing cross-linked epoxy-based coatings, while the inhibitors protect exposed metal during the stripping and rinsing steps during the method.

### EXAMPLES

The stripping composition includes petroleum solvents and an alkyl benzene sulfonic acid of suitable formulations that include the following weight proportions:

### Composition #1

### A) 3-Methoxy-3-Methyl-1-Butanol (MMB) 70-96 wt %

B) Para-Toluenesulfonic acid (PTSA) 3-20 wt %

### C) Benzotriazole (BTA) 0.2-5 wt %

### D) Tolyltriazole (TTA) 0.2-5 wt %

### E) Fluorinated Surfactant 0.05-1 wt %

The petroleum solvent is 3-methoxy-3-methyl-1-butanol (MMB) and the alkyl benzene sulfonic acid is Para-Toluenesulfonic acid (PTSA). Inhibitors for copper protection include triazole-based materials such as Benzotriazole (BTA) and Tolyltriazole (TTA).

### Composition #2

A second composition also includes a blend of alkyl-sulfonic acids and petroleum solvents of suitable formulations that include the following weight proportions:

### A) Dipropylene Glycol Monomethyl Ether (DPM) 70-96 wt %

### B) Methane Sulfonic Acid (MSA) 3-20 wt

### C) Benzotriazole (BTA) 0.2-5 wt %

### D) Tolyltriazole (TTA) 0.2-5 wt %

### E) Fluorinated Surfactant 0.05-1 wt %

Epoxy-based coatings utilized in this characterization are based upon those utilized from Rohm and Haas Electronic Materials (RHEM). The epoxy-based coatings are photoimageable and are under the trade name Intervia™ as a dielectric coating for semiconductor packaging applications. The epoxy-based coating utilized is the Intervia™ 8023-series.

Typical processing conditions for the Intervia™ 8023-series photoimageable epoxy includes coating the epoxy using a spin-coating process in the range of approximately 100-1500 rpm, soft baking the epoxy @ approximately 140° C., exposing the epoxy to UV light in the range of approximately 350-450 nm, post-exposure baking the epoxy @ approximately 100° C. (PEB), @ approximately 140° C. (PDB) and with a final cure @ approximately 200° C. Conditions where dissolution and removal of the coating may be necessary occurs at the PDB step (at partial cure) and at the PDB step (at full cure). Requirements also exist where Intervia™ 8023-series coatings at the PDB stage need to be removed from full-cure coatings of the same composition.

### Example 1

The following example is designed to demonstrate dissolving and removal of partial-cure Intervia™ 8023-series epoxy-based photoimageable coatings at process conditions at an ambient temperature. The coating is a partial-cure coating, (i.e. cured at the PDB stage only). The coating is present as a partial-cure condition directly on a silicon substrate. No patterning exists underneath the partial-cure coating, however, it is generally believed that removal of patterned or non-patterned coatings should be similar. Conditions of the example are at room temperature along with the materials listed in Table I.

TABLE I

| Specimen | Stripper Chemistry | Temperature (C.) | Time (min) | Results |
|---|---|---|---|---|
| 1 | Composition 1 | Ambient, 20 | 4.5 | Dissolved, |
| | (above) | | | removal |
| 2 | Composition 2 | Ambient, 20 | 4.3 | Dissolved, |
| | (above) | | | removal |
| 3 | Conventional | Ambient, 20 | 60 | No effect, |
| | Stripper A* | | | no change |
| 4 | Conventional | Ambient, 20 | 60 | No effect, |
| | Stripper B* | | | no change |
| 5 | Conventional | Ambient, 20 | 60 | No effect, |
| | Stripper C* | | | no change |

*A = NMP:MEA 80:20 wt % (NMP = n-methylpyrrolidone, MEA = monoethanolamine, anhydrous)
*B = DMSO:TMAH 80:20 wt % (DMSO = dimethylsulfoxide, TMAH = tetramethylammonium hydroxide, 5 hydrate)
*C = DMSO:BTMAH 80:20 wt % (DMSO = dimethylsulfoxide, BTMAH = benzyltri-
methylammonium hydroxide, anhydrous); Ref: U.S. Pat. No. 6,551,973, Moore.

### Example 2

The following example is designed to demonstrate dissolving and removal of partial-cure Intervia™ 8023-series epoxy-based photoimageable coatings at process conditions at an elevated temperature. The coating is a partial-cure coating, (i.e. cured at the PDB stage only). The coating is present as a partial-cure condition directly on a silicon substrate. No patterning exists underneath the partial-cure coating, however, it is generally believed that removal of patterned or non-patterned coatings should perform similarly. Conditions of the example are at an elevated temperature along with the materials listed in (Table II).

TABLE II

| Specimen | Stripper Chemistry | Temperature (C.) | Time (min) | Results |
|---|---|---|---|---|
| 1 | Composition 1 | 60 | <1 | Dissolved, |
| | (above) | | | removal |
| 2 | Composition 2 | 60 | <1 | Dissolved, |
| | (above) | | | removal |
| 3 | Conventional | 90-100 | 45-60 | Lift-off, no |
| | Stripper A* | | | dissolution |
| 4 | Conventional | 90-100 | 45-60 | No effect, |
| | Stripper B* | | | no change |
| 5 | Conventional | 90-100 | 45-60 | Lift-off, no |
| | Stripper C* | | | dissolution |

*A = NMP:MEA 80:20 wt % (NMP = n-methylpyrrolidone, MEA = monoethanolamine, anhydrous)
*B = DMSO:TMAH 80:20 wt % (DMSO = dimethylsulfoxide, TMAH = tetramethylammonium hydroxide, 5 hydrate)
*C = DMSO:BTMAH 80:20 wt % (DMSO = dimethylsulfoxide, BTMAH = benzyltri-
methylammonium hydroxide, anhydrous); Ref: U.S. Pat. No. 6,551,973, Moore.

### Example 3

The following example is designed to demonstrate dissolving and removal of full-cure Intervia™ 8023-series epoxy-based photoimageable coatings at process conditions of conventional stripping (i.e. immersion) described in U.S. patent application Ser. No. 12/413,085 (2009), Moore et al., involving the composition being applied to the coating, heating the coating and rinsing the coating. The coating is fully-cured, (i.e. cured at the final stage) and is present in a full-cure condition directly on a silicon substrate. No patterning exists underneath the partially-cured coating, however, it is generally believed that removal of patterned or non-patterned coatings should perform similarly. Conditions of the example are at an elevated temperature along with the materials listed in Table III.

TABLE III

| Specimen | Stripper Chemistry | Temperature (C.) | Time (min) | Results |
|---|---|---|---|---|
| 1 | Composition 1 | 200-250 | 1-2 | Dissolved, |
| | (above) | | | removal |
| 2 | Composition 2 | 200-250 | 1-2 | Dissolved, |
| | (above) | | | removal |
| 3 | Conventional | 200-250 | 1-2 | No effect, |
| | Stripper A* | | | no change |
| 4 | Conventional | 200-250 | 1-2 | No effect, |
| | Stripper B* | | | no change |
| 5 | Conventional | 200-250 | 1-2 | No effect, |
| | Stripper C* | | | no change |

Note:
process conditions follows coating, heating, rinsing (U.S. patent application No. 12/413,085 (2009), Moore et al.)
*A = NMP:MEA 80:20 wt % (NMP = n-methylpyrrolidone, MEA = monoethanolamine, anhydrous)
*B = DMSO:TMAH 80:20 wt % (DMSO = dimethylsulfoxide, TMAH = tetramethylammonium hydroxide, 5 hydrate)
*C = DMSO:BTMAH 80:20 wt % (DMSO = dimethylsulfoxide, BTMAH = benzyltri-
methylammonium hydroxide, anhydrous); Ref: U.S. Pat. No. 6,551,973, Moore.

### Example 4

The following example is designed to demonstrate the dissolving and removal of partial cure Intervia™ 8023-series epoxy-based photoimageable coatings while in contact with the same coating at a full-cure condition at process conditions at an elevated temperature. Since this example involves the removal of one epoxy cure state from another, the conventional strippers were not included as they served no benefit as identified in Table II. The coating to be removed is at a partial-cure condition and is present with patterns of large geometries. The partial-cure patterned large geometries are process cured at the PDB stage only. Underlying the patterned partial-cure coating is a uniform full-cure coating of the same composition (Intervia™ 8023-series epoxy-based). Removal of the patterned partial-cure material is readily observed (i.e. no pattern exists). This removal is observed by the use of a microscope using an objective magnification of approximately 50×. Conditions of the example include an elevated temperature and time along with the materials listed in Table IV.

TABLE IV

| | Stripper | Temperature | Time | Removal Results for |
|---|---|---|---|---|
| Specimen | Chemistry | (C.) | (min) | top layer (partial-cure) |
| 1 | Composition 1 | 60 | <1 | Dissolved, removal, no |
| | (above) | | | effect to underlying |
| | | | | layer |
| 2 | Composition 2 | 60 | <1 | Dissolved, removal, no |
| | (above) | | | effect to underlying |
| | | | | layer |

### Example 5

The following experiment is designed to demonstrate a “CMP-like” cleaning process for dissolving and removal of partial-cure Intervia™ 8023-series epoxy-based photoimageable coatings while in contact with the same coating at a full-cure condition at process conditions of elevated temperature. The process includes a fiber-free pad or brush that is compatible with the stripper composition. The CMP pad or brush is saturated with the stripper composition and brought into direct contact with said coating, initiate mechanical motion of the pad (rotation), and allowed to proceed until satisfactory removal is achieved. Since we are focusing here on removal of one epoxy cure state from another with the invention, the conventional strippers were not included as they served no benefit as identified in Table II. The coating to be removed is at a partial-cure condition and present with patterns of large geometries. The partial-cure patterned large geometries are process cured at the PDB stage only. Underlying the patterned partial-cure coating is a uniform full-cure coating of the same chemistry (Intervia™ 8023-series epoxy-based). Removal of the patterned partial-cure material is readily observed (i.e. no pattern exists). This removal is observed by the use of a microscope using an objective magnification of ˜50×. Results of the removal of patterned partial-cure from full-cure Intervia™ 8023-series epoxy-based photoimageable coatings and the conditions of temperature, time, along with the materials tested are given below (Table V).

TABLE V

| | Stripper | Temperature | Time | Removal Results for |
|---|---|---|---|---|
| Specimen | Chemistry | (C.) | (min) | top layer (partial-cure) |
| 1 | Composition 1 | 20 (RT*) | <1 | Dissolved, removal, no |
| | (above) | | | effect to underlying |
| | | | | layer |
| 2 | Composition 2 | 20 (RT*) | <1 | Dissolved, removal, no |
| | (above) | | | effect to underlying |
| | | | | layer |

*RT: room temperature

### Example 6

Galvanic corrosion studies were conducted on aluminum and copper utilized in semiconductor fabrication. The substrates were present on silicon and measurements were conducted with a XP-1 profilometer (Ambios Technology, Inc., www.ambiostech.com) during a 30 minute elevated temperature test utilizing Composition 1 (above).

TABLE VI

| Metal | Profilometry (delta) | Appearance | Remarks |
|---|---|---|---|
| Cu | <10,000 Å = <333 | Smooth, shiny | No effect |
| | Å/min, <0.03 μm/min | | (no etch) |
| Al | <500 Å* = <20 Å/min | Smooth, shiny | No effect |
| | | | (no etch) |

*Note:
these values (i.e. <333 Å/min) represent very low values when considered that geometries for the epoxy-coating will be on the order of tens of microns (>>10 μm). Further, the process times noted here are 30X that of what is expected for the invention (i.e. <1 min).

Results of galvanic corrosion testing in the given invention compositions indicate that the measured value by profilometry is low, or at the detection level of the instruments used for this evaluation when considering conducting processing of epoxy-based coatings at <1 min.

Although the invention has been described in terms of specific tests and embodiments, it will be apparent that one skilled in the art can substitute other known variants, tests and embodiments without departing from the essence of the invention. Accordingly, the invention is only to be limited by the scope of the appended claims.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A composition to remove epoxy-based photoimageable coatings, comprising:
a solvent system to dissolve and rinse away said coating; and
an acidic additive that hydrolyzes said coating and releases a plurality of monomeric forms to said solvent.

2. The composition according to claim 1, wherein said solvent system is selected from the group consisting of one or more esters of structure R—CO2R1, glycol ether esters of structures R2-CO2C2H4OC2H4-OR3, R4-CO2C3H6OC3H6-OR5 or R6OCO2R7, alcohols selected from structures R8OH, R9OC2H4OC2H4OH, R10OC3H6OC3H6OH, R11OC2H4OH, or R12OC3H6OH, ketones selected from structure R13COR14, sulfoxides selected from structure R15SOR16, or amides that include N,N-dimethyl formamide, N,N-dimethyl acetamide, or N-methylpyrolidone.

3. The composition according to claim 2, wherein R, R1, R2, R3, R4, R5, R6, R7, R8, R9, R10, R11, R12, R13, R14, R15, or R16 are selected from the group consisting of C1-C14 alkyl groups.

4. The composition according to claim 2, wherein R, R1, R13, R14 are selected from the group consisting of C1 to C8 alkyl groups.

5. The composition according to claim 2, wherein said solvent system is selected from the group consisting of primary solvents that include ketones that include cyclohexanone, 2-heptanone, methyl propyl ketone, or methyl amyl ketone, esters that include isopropyl acetate, ethyl acetate, butyl acetate, ethyl propionate, methyl propionate, gammabutyrolactone (BLO), ethyl 2-hydroxypropionate (ethyl lactate (EL)), ethyl 2-hydroxy-2-methyl propionate, ethyl hydroxyacetate, ethyl 2-hydroxy-3-methyl butanoate, methyl 3-methoxypropionate, ethyl 3-methoxy propionate, ethyl 3-ethoxypropionate, methyl 3-ethoxy propionate, methyl pyruvate, or ethyl pyruvate, ethers or glycol ethers that include diisopropyl ether, ethyleneglycol monomethyl ether, ethyleneglycol monoethyl ether, or propylene glycol monomethyl ether (PGME), glycol ether esters that include ethyleneglycol monoethyl ether acetate, propyleneglycol methyl ether acetate (PGMEA), or propyleneglycol propyl ether acetate, aromatic solvents, that include methylbenzene, dimethylbenzene, anisole, or nitrobenzene, amide solvents that include N,N-dimethylacetamide (DMAC), N,N-dimethylformamide, or N-methylformanilide, or pyrrolidones that include N-methylpyrrolidone (NMP), N-ethylpyrrolidone (NEP), dimethylpiperidone, 2-pyrrole, N-hydroxyethyl-2-pyrrolidone (HEP), N-cyclohexyl-2-pyrrolidone (CHP), or sulfur containing solvents that include dimethyl sulfoxide, dimethyl sulfone or tetramethylene sulfone.

6. The composition according to claim 1, wherein said acidic additive is selected from the group consisting of approximately 100 parts-per-million (ppm) to approximately 95 weight percent of an alkyl-sulfonic acid that includes methanesulfonic (MSA), para-toluenesulfonic (PTSA), or dodecylbenzene sulfonic acid (DDBSA), formic acid, fatty acids, sulfuric acid, nitric acid, or phosphoric acids.

7. The composition according to claim 1, wherein said composition includes a plurality of inhibitors that are selected from the group consisting of chelating, complexing, or reducing agents, including benzylic hydroxides that include catechol, triazoles, imidazoles, borates, phosphates, or alkyl or elemental silicates, ethylenediaminetetraacetic acid, diethylenetriaminepentaacetic acid, nitrilotriacetic acid, or 2,4-pentanedione, reducing sugars, hydroquinones, glyoxal, salicylaldehyde, fatty acids that include citric or ascorbic acid, hydroxylamines, or vanillin.

8. The composition according to claim 1, wherein said composition includes one or more surfactants selected from the group consisting of nonionic nonyl-phenols or nonyl-ethoxylates, anionic forms that include alkyl-sulfonates, phosphate esters, or succinates, or fluorinated systems.

9. The composition according to claim 1, wherein said composition includes said solvent system that is in the range of 5-96 percent weight 3-Methoxy-3-Methyl-1-Butanol (MMB), said acidic additive that is an alkyl sulfonic acid that is in the range of 3-20 percent weight Para-Toluenesulfonic acid (PTSA), said inhibitors that are in the range of 0.2-5.0 percent weight Benzotriazole (BTA) and in the range of 0.2-5.0 percent weight Tolyltriazole (TTA) and said surfactant that is in the range of 0.05-1.0 percent weight fluorinated surfactant.

10. The composition according to claim 1, wherein said solvent system is in the range of 5-96 percent weight Dipropylene Glycol Monomethyl Ether (DPM), said acidic additive is in the range of 3-20 percent weight Methane Sulfonic Acid (MSA), said inhibitors that are in the range of 0.2-5.0 percent weight Benzotriazole (BTA) and in the range of 0.2-5.0 percent weight Tolyltriazole (TTA) and said surfactant that is in the range of 0.05-1.0 percent weight fluorinated surfactant.

11. The composition according to claim 1, wherein said coatings are utilized in microelectronics fabrication and in semiconductor production.

12. A method for removing a partial cured epoxy-based photoimageable coating from a substrate with a composition to remove epoxy-based photoimageable coatings, comprising:
applying said composition to said coating utilizing a sprayer, an immersion bath, wipe, or brush;
exposing said composition directly on said coating for a predetermined period of time at a predetermined temperature; and
rinsing and drying said exposed substrate.

13. The method according to claim 12, wherein said period of time is approximately less than 5 minutes.

14. The method according to claim 12, wherein said temperature is in the approximate range of 20° C. to 100° C.

15. The method according to claim 12, wherein said coatings are utilized in microelectronics fabrication and semiconductor production.

16. A method for removing a fully cured epoxy-based photoimageable coating, comprising:
applying said composition to said coating;
heating said substrate at a predetermined temperature and a predetermined period of time to allow said composition to penetrate said coating and initiate bond-breaking of said coating;
rinsing said substrate and said coating with water; and
drying said substrate.

17. The method according to claim 16, wherein said temperature is in the range of 200-250° C.

18. The method according to claim 16, wherein said period of time is less than one minute.

19. The method according to claim 16, wherein said rinsing washes away said coating.

20. The method according to claim 16, wherein said coatings are utilized in microelectronics fabrication and in semiconductor production.
